(19) United States
(12) Patent Application Publication
(10) Pub. No.: US 2015/0367613 A1
(43) Pub. Date: Dec. 24, 2015

(54) POROUS FILM

(71) Applicant: CANON KABUSHIKI KAISHA, Tokyo (JP)

(72) Inventors: Kyosuke Deguchi, Yokohama-shi (JP); Toru Yamane, Yokohama-shi (JP); Ryosuke Hirokawa, Kawasaki-shi (JP); Toru Ohnishi, Yokohama-shi (JP); Akihiro Mouri, Fuchu-shi (JP); Noboru Toyama, Kawasaki-shi (JP)

(21) Appl. No.: 14/738,699

(22) Filed: Jun. 12, 2015

(30) Foreign Application Priority Data
Jun. 18, 2014 (JP) 2014-125607

(51) Int. Cl. B32B 27/12; B32B 5/24; B32B 27/32; B32B 5/02

(52) U.S. Cl. CPC B32B 27/12; B32B 5/022; B32B 5/245; B32B 27/322; B32B 2307/724; B32B 2262/14

(57) ABSTRACT

A porous film includes a first layer made of a porous fluororesin and a second layer. The first layer has a thickness of 20 μm or less and a water resistance, measured by Method B of the Hydrostatic Pressure Test specified in JIS L 1092, of 200 kPa or more. The second layer has an average distance between local peaks, specified in JIS B 0601: 1994, in the range of 3 μm to 40 μm.

### BACKGROUND OF THE INVENTION

1. Field of the Invention

The present application relates to a porous film.

2. Description of the Related Art

Films have been studied for filtering dust or foreign matter out of gas or liquid. The films are produced by stacking porous materials having high collection efficiencies (Japanese Patent Laid-Open Nos. 2013-063424, 2006-061808 and 2000-176226. Japanese Patent Laid-Open No. 2013-063424 discloses a porous film used as an air filter medium for collecting dust from airflow. This porous film includes a support layer made of a spunbond non-woven fabric, and a principal collection layer made of a porous polytetrafluoroethylene (PTFE) film, a polypropylene (PP) pre-collection layer and a PP air-permeable cover layer in that order on the support layer. Japanese Patent Laid-Open No. 2006-061808 discloses a porous film used as an air-permeable mask filter. This film includes a porous PTFE layer and an air-permeable support member located upstream of the airflow from the porous PTFE film. Japanese Patent Laid-Open No. 2000-176226 discloses a porous film defined by an integrated multilayer composite including a porous PTFE layer and an air-permeable substrate, and further an air-permeable protective layer having a higher smoothness than the air-permeable substrate and disposed between the porous PTFE film and the air-permeable substrate.

### SUMMARY OF THE INVENTION

According to an aspect of the present application, there is provided a porous film including a first layer made of a porous fluororesin and a second layer. The first layer has a thickness of 20 μm or less and a water resistance, measured by Method B of the Hydrostatic Pressure Test specified in JIS L 1092, of 200 kPa or more. The second layer has an average distance between local peaks, specified in JIS B 0601: 1994, in the range of 3 μm to 40 μm.

Further features of the present invention will become apparent from the following description of exemplary embodiments.

### DESCRIPTION OF THE EMBODIMENTS

According to some studies of the present inventors, the porous films disclosed in the above-cited patent documents raise problems of PTFE deformation or air permeability decrease in some cases. The present application provides a less deformable and highly air-permeable porous film. The present application will be further described using exemplary embodiments.

The present inventors have found, through their studies on the porous films of the above-cited patent documents, that the average distance between local peaks of the layer layered on the porous fluororesin layer such as a PTFE layer is involved in the problems. More specifically, a layer layered on a porous fluororesin layer having a larger average distance between local peaks is more liable for deformation of the porous fluororesin layer, whereas a layer layered on a porous fluororesin layer having a smaller average distance between local peaks causes a lower air permeability.

The present inventors have studied a structure including a porous fluororesin layer (first layer) and an overlying layer (second layer) about the water resistance and thickness of the porous fluororesin layer and the average distance between local peaks of the overlying layer, and found that the structure according to an embodiment of the application can achieve both reduced deformation and high air permeability.

More specifically, the structure of the porous film includes a first layer made of a porous fluororesin and a second layer. The first layer has a water resistance of 200 kPa or more, and a thickness of 20 μm or less, and the second layer has an average distance between local peaks is in the range of 3 μm to 40 μm. The water resistance mentioned herein is the value measured by Method B (high pressure test) specified in JIS L 1092, and the average distance between local peaks mentioned herein is the value specified in JIS B 0601: 1994.

Although the reason why the above structure is effective is not clear, the present inventors assume that an appropriate contact area between the first layer and the second layer contributes to increase in stiffness and to suppression of deformation with air permeability maintained. Porous Film

The porous film according to an embodiment of the application includes a first layer and a second layer. The porous film may further include a third layer on the second layer. In other words, the porous film may include the first layer, the second layer and the third layer in that order. The third layer may be provided with another layer thereon. These layers may be separated by another layer disposed therebetween as long as the advantageous effects of the application can be produced. It is however advantageous that first layer and the second layer are adjacent to each other. Pore size in each layer may be different at the points in the thickness direction of the layer.

The porous film of the embodiment has such a tensile strength that it begins plastic deformation at a load of 200 N/m or more per unit width, preferably 300 N/m or more and 4,000 N/m or less per unit width, in the tensile test specified in JIS L 1913: 2010. This point, at which plastic deformation begins in the porous film, is hereinafter referred to as the plastic deformation start point. In the Examples of the application, the tensile test was performed using a tensile tester AKG-kNX (manufactured by Simadzu). In the tensile test, samples measuring 25 mm±0.5 mm by 150 mm were measured at a grasping length of 50 mm±0.5 mm and a tensile speed of 20±0.02 mm/min. The load per unit width at the plastic deformation start point is obtained by dividing the load at the plastic deformation start point by the width of the sample.

Desirably, the porous film has an air resistance, measured with a Gurley tester specified in JIS P 8117, of 10 s or less, such as 7 s or less, preferably 3 s or less. The lower the Gurley value, the higher the air permeability.

The component layers of the porous film of the embodiment will now be described.

### First Layer

The first layer is made of a fluororesin.

Fluororesins have low surface free energy and easy to clean. Exemplary fluororesins include polytetrafluoroethylene (PTFE), polychlorotrifluoroethylene (PCTFE), poly(vinylidene fluoride) (PVDF), poly(vinyl fluoride) (PVF), perfluoroalkoxy resin (PFA), tetrafluoroethylene-hexafluoropropylene copolymer (FEP), ethylene-tetrafluoroethylene copolymer (ETFE), and ethylene-chlorotrifluoroethylene copolymer (ECTFE). These resins may be used singly or in combination, and the fluororesin layer may be a multilayer composite of layers of different fluororesins. In the present embodiment, the water resistance of the first layer measured by Method B of the Hydrostatic Pressure Test specified in JIS L 1092 is 200 kPa or more. Desirably, the water resistance is 300 kPa or more.

The thickness of the first layer is 20 μm or less. Desirably, the thickness of the first layer is 15 μm or less and is 3 μm or more. In the Examples, the thickness was determined by averaging the measurements at randomly selected 10 points measured with Linear Micrometer OMV-25 (manufactured by Mitutoyo).

The arithmetic average surface roughness Ra specified in JIS B 0601: 2001 of the first layer is may be 1.9 μm or less, such as 1.5 μm or less, and is preferably 1.0 μm or less, more preferably 0.4 μm or less. For measuring the surface profile, reflection from a measuring region is scanned in the Z axis direction with a laser microscope using a pinhole confocal optical system (using, for example, a semiconductor laser beam having a wavelength of about 405 nm), and the scanning data are synthesized. For the surface roughness evaluated in the Examples, the portion from the surface to a depth of 200 μm was measured with a laser microscope VK 9710 (manufactured by Keyence) using an objective lens with a magnification of 50 times (CF IC EPI PLAN Apo 50× manufactured by Nikon) in an RPD mode. The resulting data was processed through a noise filter (median filter) for calculation (cut off λc: 0.08 μm, reference line length: 200 μm).

### Second Layer

The arithmetic average surface roughness Ra specified in JIS B 0601: 2001 of the second layer is may be 10 μm or less, such as 6.0 μm or less, and is preferably 4.0 μm or less.

In the present embodiment, the average distance between local peaks of the second layer, specified in JIS B 0601: 1994 is in the range of 3 μm to 40 μm. In the present embodiment, the average distance between local peaks may be substituted by the mean width of the profile elements RSm, specified in JIS B0601:2001. Preferably, the average distance between local peaks is in the range of 3 μm to 15 μm.

For measuring the surface profile, reflection from a measuring region is scanned in the Z axis direction with a laser microscope using a pinhole confocal optical system (using, for example, a semiconductor laser beam having a wavelength of about 405 nm), and the scanning data are synthesized. For the average distance between local peaks evaluated in the Examples, the portion from the surface to a depth of 200 μm was measured with a laser microscope VK 9710 (manufactured by Keyence) using an objective lens with a magnification of 50 times (CF IC EPI PLAN Apo 50× manufactured by Nikon) in an RPD mode. The resulting data was processed through a noise filter (median filter) for calculation (cut off λc: 0.08 μm, reference line length: 200 μm).

Advantageously, the second layer is permeable to air. Examples of the material having more permeable to air than the first layer include non-woven fabric, woven fabric, mesh (net) and other porous materials. Non-woven fabric is advantageous from the viewpoint of strength, flexibility, and workability.

In the present embodiment, it is advantageous that the second layer contains (1) two types of fibers; or (2) fibers containing two materials. Each case will be described below. In the description herein, the term “softening point” is melting point for fibers having melting points, or glass transition temperature for fibers having glass transition temperatures, but not melting points. In the Examples, the average fiber diameter of fibers was determined from the diameters measured at randomly selected 10 or more points of the surface of the fibers observed through a scanning electron microscope.

### (1) In the Case Where the Second Layer Contains First Fibers and Second Fibers

The two types of fibers may be mixed, or have a core-sheath structure including a core and a sheath. The first fibers have an average fiber diameter in the range of 0.1 μm to 15.0 μm, such as 0.1 μm to 10.0 μm, and preferably in the range of 0.1 μm to 5.0 μm. The second fibers have an average fiber diameter in the range of 0.1 μm to 15.0 μm, such as 0.1 μm to 10.0 μm, and preferably in the range of 0.1 μm to 5.0 μm.

Advantageously, the two types of fibers have different average fiber diameters and/or different softening points. It may be advantageous, for example, that the first fibers and the second fibers satisfy at least either the following condition (1) or condition (2), while the mass ratio in the second layer of the first fibers to the second fibers is in the range of 20:80 to 80:20.

Condition (1): The average fiber diameter of the first fibers is larger than that of the second fibers; and the average fiber diameter of the first fibers is 1.2 times to 50.0 times relative to the average fiber diameter of the second fibers.

Condition (2): The difference in softening point between the first fibers and the second fibers is 10° C. or more [|(softening point of the first fibers)−(softening point of the second fibers)|≧10° C.]

### (2) In the Case Where the Second Layer Contains Fibers Containing a First Material and a Second Material

The fibers in the second layer have an average fiber diameter in the range of 0.1 μm to 15.0 μm, such as 0.1 μm to 10.0 μm, and preferably in the range of 0.1 μm to 5.0 μm. Desirably, the first material and the second material have different softening points with a difference of 10° C. or more. Furthermore, it is advantageous that the mass ratio of the first material to the second material be in the range of 20:80 to 80:20.

The present inventors believe that the adhesion area between the first and second layers and the distances between the adhesion points are reduced when the first layer and the second layer satisfy at least either of the above conditions, and that consequently both the air permeability and the adhesion between the first and the second layers increase.

Exemplary materials of the second layer include, but are not limited to, polyolefin such as polyethylene (PE) and polypropylene (PP), polyurethane, nylon, polyamide, polyester such as polyethylene terephthalate (PET), polysulfone (PSF), and fluororesin, and composites of these materials.

### Third Layer

The porous film of the present embodiment may include a third layer, as mentioned above. The third layer may be made of any of the materials cited as the material of the second layer. From the viewpoint of stiffness, non-woven fabric is advantageous. The third layer desirably has a smooth surface. The average pore size of the third layer is desirably larger than that of the second layer. The average pore size mentioned herein is the value measured with the pore diameter distribution measuring apparatus PERMPOROMETER CFP-1200A (manufactured by PMI Co.).

Desirably, the fiber having the lowest softening point of the fibers in the third layer has a difference in softening point of 5° C. or more from the fiber having the lowest softening point of the fibers in the second layer. In the present embodiment, the fibers of the third layer may have a core-sheath structure in which the sheaths of the fibers have a lower softening point than the cores.

### Method for Manufacturing Porous Film

The porous film may be manufactured by a process including, but not limited to, forming the first layer, forming the second layer, and stacking the first and second layers.

A method for manufacturing a porous film using PTFE will be described below by way of example.

A lubricant is added to a PTFE fine powder and uniformly mixed together. The PTFE fine powder may be, for example, Polyflon F-104 (produced by Daikin) or Fluon CD-123 (produced by Asahi Glass). The lubricant may be, for example, a mineral spirit or naphtha.

The lubricant-treated PTFE fine powder is formed into pellets in a cylinder by compression. The pellets unbaked are formed into a sheet by extrusion using a ram extruder, and rolled between pair rollers to a thickness of, normally, 0.05 mm to 0.7 mm. The rolled sheet is heated to remove the lubricant, thus yielding a PTFE sheet.

The resulting PTFE sheet is drawn in the longitudinal direction thereof (rolling direction) while being heated, and then drawn in the width direction thereof while being heated. By altering the manners of heating and drawing of the PTFE sheet, the pore size, porosity and thickness of the resulting porous material are varied.

If the PTFE sheet is drawn in one or more axis direction at a relatively high speed while heating to a temperature lower than the softening point of the PTFE, the PTFE porous material has a fiber structure having large knots of larger than 1 μm formed by connecting very fine fibers one another. The porous material has a porosity as high as 40% to 97% and very high strength. The PTFE sheet may be semi-baked and then drawn, or may be drawn after being heated or while being heated to a temperature higher than or equal to the softening point (327° C.) of the PTFE. Alternatively, a film formed by hot pressing of fluororesin fiber produced by electrospinning (ES) or the like may be used.

If a non-woven fabric is used as the second layer, fibers of fleece produced by a dry process, a wet process, span bonding, ES or the like may be bound to each other by chemical bonding, thermal bonding, a needle punch method, hydroentangling or the like.

For stacking the first layer and the second layer, the layers may be simply stacked or bound to each other by, for example, adhesive lamination or thermal lamination. From the viewpoint of air permeability, thermal lamination is advantageous. For example, the first layer and the second layer may be bound by melting part of the first or second layer by heating. Alternatively, the first layer and the second layer may be bound by heating with a welding agent such as hot melt powder therebetween. For thermal lamination, for example, it is advantageous to heat the stack of the layers from the layer whose fiber having the lowest thermal softening point of the fibers therein has a higher thermal softening point than the fiber having the lowest softening point of the fibers in the other layer. By heating the layer having a higher thermal softening point, only the surface and vicinity thereof of the layer having a lower thermal softening point can be softened. This prevents the degradation of air permeability.

The third layer may be stacked together with the first and the second layer, or the three layers may be stacked one after another. The order of stacking may be appropriately determined.

### EXAMPLES

The application will be further described in detail with reference to Examples and Comparative Examples. The invention is however not limited to the following Examples.

PTFE films having a thickness, an average surface roughness Ra and a water resistance shown in Table 1 were prepared as the first layer.

TABLE 1
First Layer Physical Properties

| | Thickness | Ra | Water resistance |
|---|---|---|---|
| First layer | (μm) | (μm) | (kPa) |
| 1-a | 15 | 0.3 | 200 |
| 1-b | 15 | 0.3 | 150 |
| 1-c | 40 | 0.3 | 200 |

For the second layer, were prepared films (2-a, 2-b, 2-c, 2-f and 2-g) containing polyethylene (first fibers) having a thickness, an average surface roughness Ra and an average distance between local peaks shown in Table 2, and films (2-d and 2-e) containing polyethylene (first fibers) and polypropylene (second fibers).

TABLE 2
Second Layer Physical Properties and Materials

| | | | | Constituent materials | | | | |
|---|---|---|---|---|---|---|---|---|
| | | | | | | | | Mass Ratio |
| | Physical properties | | | | | | | of first fiber |
| | | | Average | First fiber | | Second fiber | | to Second |
| | | | distance | Average | | Average | | fiber |
| | | | between local | fiber | Softening | fiber | Softening | (First fiber: |
| Second | Thickness | Ra | peaks | diameter | point | diameter | point | second |
| layer | (μm) | (μm) | (μm) | (μm) | (° C.) | (μm) | (° C.) | fiber) |
| 2-a | 150 | 10 | 20 | 5 | 100 | — | — | — |
| 2-b | 50 | 10 | 20 | 5 | 100 | — | — | — |
| 2-c | 50 | 3.5 | 20 | 5 | 100 | — | — | — |
| 2-d | 50 | 10 | 20 | 5 | 100 | 0.3 | 160 | 1:1 |
| 2-e | 50 | 3.5 | 20 | 5 | 100 | 0.3 | 160 | 1:1 |
| 2-f | 150 | 10 | 1 | 5 | 100 | — | — | — |
| 2-g | 150 | 10 | 50 | 5 | 100 | — | — | — |

A 100 μm thick polypropylene film was formed as the third layer. Then, the first, the second and the third layer were stacked to yield porous films in the combinations shown in the following Table 3 by hot press lamination. The resulting porous films were subjected to measurements for Gurley values and Yield values by the following methods. The results are shown in Table 3.

TABLE 3
Porous film structure and physical properties

| | Layers | | | Physical properties | |
|---|---|---|---|---|---|
| | | | Third | Load (N/m) at | Gurley |
| | First | Second | layer | plastic deformation | value |
| Example No. | layer | layer | presence | start point | (s) |
| Example 1 | 1-a | 2-a | No | 200 | 9 |
| Example 2 | 1-a | 2-b | No | 200 | 4 |
| Example 3 | 1-a | 2-c | Yes | 400 | 4 |
| Example 4 | 1-a | 2-d | No | 200 | 3 |
| Example 5 | 1-a | 2-e | Yes | 400 | 3 |
| Comparative | 1-b | 2-a | No | 200 | 6 |
| Example 1 | | | | | |
| Comparative | 1-c | 2-a | No | 200 | 13 |
| Example 2 | | | | | |
| Comparative | 1-a | 2-f | No | 200 | 14 |
| Example 3 | | | | | |
| Comparative | 1-a | 2-g | No | 200 | 6 |
| Example 4 | | | | | |

### Evaluation

The resulting porous films were evaluated by the following methods. The results are shown in Table 4. In each evaluation, ratings AA to B represent that the results were good, and rating C represents that the results were unacceptable.

### Effect of Reducing Local Deformation

Each of the resulting porous films was used as a filter, and the degree of the deformation of the first layer was observed. The rating criteria were as follows.
B: Deformation was not observed, or very small deformation was observed, but was on an acceptable level.
C: Large deformation was observed.

### Filtration Performance

Each porous film was set in a circular holder having an effective area of 100 cm², and air containing dust (5×10⁵ particles/L of quartz particulate matter having a particle size of 2 μm or less) was introduced at a permeation rate of 5.3 cm/s through the porous film. The density of the particles (particles/L) was measured upstream from the porous film and downstream from the porous film with a particle counter KC-18 (manufactured by Rion). The collection efficiency was calculated using the following equation. A higher collection efficiency implies that the porous film has higher filtration performance. The rating criteria were as follows.

Collection efficiency (%)=(1−particle density at downstream side/particle density at upstream side)×100
A: Collection efficiency was 99% or more.
B: Collection efficiency was 98% to less than 99%
C: Collection efficiency was less than 98%.

### Adhesion

The adhesion of the porous film used as a filter was evaluated by observing whether or not separation occurred between the layers. The rating criteria were as follows:
B: There was no separation.
C: Separation occurred between the layers.

### Effect of Reducing Pressure Distribution

For evaluating the effect of reducing pressure distribution, the porous film was used as a wiping member for maintenance of an ink jet printer. Ink droplets, dirt, dust and paper dust were wiped off from the nozzle face having nozzles through which ink is ejected by relatively moving the porous film and the head with the porous film abutted on the nozzle face with an abutting member. In this instance, the porous film was conveyed with a take-up roller in a roll-to-roll manner. It was checked whether or not nonuniformity resulting from wiping was found by observing the surface of the nozzle face after being wiped through an optical microscope. As the degree of nonuniformity is lower, pressure distribution can be reduced more effectively. The rating criteria were as follows:
A: Nonuniformity resulting from wiping was not observed.
B: Little nonuniformity was observed, but was on an acceptable level.
C: Nonuniformity resulting from wiping occurred.

### Ease of Conveyance

The porous film was used as a wiping member by being conveyed in a roll-to-roll manner, and it was checked whether or not the film was deformed by tension applied for conveyance. As the degree of deformation is lower, the porous film is easier to convey. The rating criteria were as follows:
A: Plastic deformation was not observed, and further tension was applied.
B: Plastic deformation was not observed.
C: Plastic deformation was observed.

TABLE 4
Evaluation results

| | | | | Effect of reducing | |
|---|---|---|---|---|---|
| | Effect of reducing | Filtration | | pressure | Ease of |
| Example No. | local deformation | performance | Adhesion | distribution | conveyance |
| Example 1 | B | B | B | B | B |
| Example 2 | B | B | B | B | B |
| Example 3 | B | B | B | A | A |
| Example 4 | B | A | B | B | B |
| Example 5 | B | A | B | A | A |
| Comparative | B | C | B | B | B |
| Example 1 | | | | | |
| Comparative | B | A | B | B | B |
| Example 2 | | | | | |
| Comparative | B | A | B | B | B |
| Example 3 | | | | | |
| Comparative | C | A | B | B | B |
| Example 4 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-125607, filed Jun. 18, 2014, which is hereby incorporated by reference herein in its entirety.

What is claimed is:

1. A porous film comprising:
a first layer made of a porous fluororesin, the first layer having a thickness of 20 μm or less and a water resistance, measured by Method B of the hydrostatic pressure test specified in JIS L 1092, of 200 kPa or more; and
a second layer having an average distance between local peaks specified in JIS B 0601: 1994 in the range of 3 μm to 40 μm.

2. The porous film according to claim 1, wherein the porous film has a Gurley value, measured in accordance with JIS P 8117, of 10 s or less.

3. The porous film according to claim 1, further comprising a third layer on the second layer, the third layer has a larger average pore size than the second layer.

4. The porous film according to claim 1, wherein the first layer has an arithmetic average surface roughness of 1.9 μm or less and the second layer has an arithmetic average surface roughness of 10 μm or less, the arithmetic average surface roughness being specified in JIS B 0601:
2001, and wherein the porous film has a tensile strength such that the load per unit width of the porous film at the plastic deformation start point is 200 N/m or more.

5. The porous film according to claim 1, wherein the second layer contains first fibers having an average fiber diameter in the range of 0.1 μm to 15.0 μm and second fibers having an average fiber diameter in the range of 0.1 μm to 15.0 μm with a mass ratio of the first fibers to the second fibers in the range of 20:80 to 80:20, and wherein the first fibers and the second fibers satisfy at least one of the following conditions (1) and (2):
(1): the first fibers have a larger average fiber diameter than the second fibers, and the proportion of the average fiber diameter of the first fibers is in the range of 1.2 to 50.0 relative to the average fiber diameter of the second fibers; and
(2): the difference in softening point between the first fibers and the second fibers is 10° C. or more.

6. The porous film according to claim 1, wherein the second layer contains fibers having an average fiber diameter in the range of 0.1 μm 15.0 μm and containing a first and a second material having different softening points with a difference of 10° C. or more, and the mass ratio of the first material to the second material is in the range of 20:80 to 80:20.
